(19) United States
(12) Patent Application Publication
(10) Pub. No.: US 2023/0012254 A1
(43) Pub. Date: Jan. 12, 2023

(54) HUMAN RESOURCES MANAGEMENT SYSTEM

(71) Applicant: Richard M. Ehrgott, Tampa, FL (US)

(72) Inventor: Richard M. Ehrgott, Tampa, FL (US)

(21) Appl. No.: 17/811,742

(22) Filed: Jul. 11, 2022

Related U.S. Application Data
(60) Provisional application No. 63/203,116, filed on Jul. 9, 2021.

(51) Int. Cl. G06Q 10/10; G06Q 10/06

(52) U.S. Cl. CPC G06Q 10/105; G06Q 10/063112

(57) ABSTRACT

A system and a method for managing human resources to provide employees to clients having job openings associated with projects use a desktop application and a mobile application to communicate with the clients, the employees and field managers. The clients and the field managers use the desktop application to enter into the system information related to projects, available jobs and candidate employees and to match employees with the jobs. The employees and the field managers use the mobile application to enter into the system employee profile information including skill sets, employee available dates and interest in available jobs.

### CROSS-REFERENCE TO RELATED APPLICATIONS

This application claims the benefit of U.S. provisional patent application Ser. No. 63/203,116 filed Jul. 9, 2021.

### FIELD OF THE INVENTION

This invention relates to a human resources management system and a method of operating the system.

### BACKGROUND OF THE INVENTION

This section provides background information related to the disclosure which is not necessarily prior art.

U.S. Pat. No. 7,945,522 B2, entitled “Match-based Employment System and Method”, describes a method of operating an employment system that includes generating a score for each of a plurality of possible results compared to information associated with a user, enabling the user to access a result of the plurality of possible results if the score generated for the result meets a threshold condition, enabling the user to adjust the threshold condition and preventing the user from adjusting the threshold condition beyond a minimum threshold condition. The score can be a bi-directional matching score. The minimum threshold condition can include a minimum score. The minimum score can be determined based on the percentage of the plurality of possible results that would be accessible to the user.

US 2009/0132313 A1, entitled “Human Resource Management System”, describes a human resource management system, designed in particular, for recruitment selection, personnel management and career guidance. In a first aspect the invention is a computer system, in a second aspect a computer operated method, and in a third aspect software for performing the method. The invention involves a database to store descriptions of jobs each of which is defined by competencies, a database to store descriptions of candidates each of which is defined by competencies, a processor operable to automatically report a ranked match between a single job and many candidates based on matching competencies, or to automatically report a ranked match between a single candidate and many jobs based on matching competencies, and a user interface to display the resulting report.

US 2019/0385112 A1, entitled “Method and Apparatus of Matching Candidate Substitute Teachers to Client Schools”, describes a method and apparatus for matching an available qualified candidate substitute teacher to a client school using a rules-based mathematical algorithm to calculate a score for the candidate for matching with a degree of restrictiveness between one and three of a client school. The apparatus may comprise a mobile telecommunications device having a processor for receiving a special purpose computer application for providing at least one available qualified candidate at a predetermined start time, end time and duration during a school year. A search manager server may control a plurality of search engines for automatically verifying data initially received from one of a client school and a candidate. Once a match is made, a qualified candidate placed at a client school or a client school may periodically provide feedback to update a candidate client school database for the client school.

### SUMMARY OF THE INVENTION

According to the invention, a system for managing human resources to provide employees to clients having job openings associated with projects includes: a computing system operatively wirelessly operatively coupled over a wireless communication network with a plurality of user portable devices and a plurality of client devices; the computing system including a processing device connected to a data storage device and communication interface, the communication interface communicatively coupled to the communication network; a memory device storing executable code that, when executed, causes the processing device to run a desktop application that stores information for a plurality of clients, a plurality of projects associated with the clients, a plurality of job openings associated with the projects and a plurality of profiles of employees in the data storage device, the employees being represented by an operator of the system; the client devices communicating with the computing system across the wireless communication network to provide the information related to the projects and the job openings to be stored in the data storage device; and the user portable devices each including a user processing device connected to a user memory device storing executable code that, when executed, causes the user processing device to run a mobile application that connects the user portable device to the wireless communication network to provide information related to the profiles and to search the job openings.

The system, when running the desktop application, generates a Dashboard page on a display, the Dashboard page including a New Candidates list, a Candidates Available Soon list, a Placements Ending Soon list and a Placements Ongoing list, wherein the New Candidates list includes names of new candidates that can be clicked on to access an associated one of the employee profiles.

The system, when running the desktop application, generates a Messages page on a display, wherein the Messages page includes a list of contact names each of which can be selected for sending a message.

The system, when running the desktop application, generates a Candidates page on a display, wherein the Candidates page includes a list of candidate names associated with the employee profiles maintained in the data storage device, each of candidate names being displayed with associated contact and profile information such as email addresses, telephone numbers and availability for jobs.

The system, when running the desktop application, generates a Clients page on a display, the Clients page including a list of the clients maintained in the data storage device, each of the client names being displayed with associated contact information.

The system when running the desktop application, generates a Projects page on a display, the Projects page including a list the projects maintained in the data storage device, each of the projects being displayed with associated project ID, project name, project description, client name and client address.

The system, when running the desktop application, generates a Jobs page on a display, the Jobs page including a list the jobs associated with the projects maintained in the data storage device, each of the jobs being displayed with associated job ID, client name, job start and end dates, billing rates and pay rates.

The system, when running the desktop application, generates a Placements page on a display, the Placements page including a list placed candidates names maintained in the data storage device, each of the candidate names being displayed with associated placement ID, job title, job start and end dates, dates on which various requirements were completed, billing rates and pay rates.

The system, when running the desktop application, generates a Favorite List page on a display, the Favorite List page including names of frequently used links selected by a user of the computing system.

The system, when running the desktop application, generates an Email page on a display in response to a selection of a contact stored in the data storage device, the Messages page enabling a user of the computing system to send email messages with picture attachments.

The system, when running the mobile application, generates a Home page on a portable device display of one of the user portable devices, the Home page including a “Find your next job” search feature and a “Latest News” list of stories related to industries of interest.

The system, when running the mobile application, generates a Jobs page on a portable display of one of the user portable devices, the Jobs page including a list available jobs and associated start dates stored in the data storage device.

The system, when running the mobile application, generates a Job Detail page when one the available jobs listed on the Jobs page is selected, the Job Detail page showing a job title, a job description, a duration of the job and any benefits provided.

The system, when running the mobile application, generates a Right to Represent Form page accessed from the Job Detail page, the page Right to Represent Form page enabling a user of the one user portable device to agree to representation by the operator of the system as a requirement to be considered for one of the listed jobs.

The system, when running the mobile application, generates a Messages page on a portable device display of one of the user portable devices, the Messages page listing messages sent and received by the user of the one user portable device and enables the user to send new messages.

The system, when running mobile application, generates a MyJobs page on a portable device display of one of the user portable devices, the MyJobs page jobs of interest selected by the user of the one user portable device and whether a Right to Represent form has been signed by the user.

The system, when running the mobile application, generates a Profile page accessed from the MyJobs page, the Profile page enabling the user to provide personal information including contact information and work skills.

The system, when running the mobile application, generates a Skill Sets page accessed from the Profile page, the Skill Sets page listing skill sets that can be selected by the user to include in the profile of the user.

According to the invention, a method for managing human resources to provide employees to clients having job openings associated with projects includes the following steps: proving the system described above; enabling a plurality of clients to communicate with the system over the wireless communication network using the desktop application; and enabling a plurality of users to communicate with the system over the wireless communication network using the mobile application.

The method includes enabling a plurality of field managers to communicate with the system over the wireless communication network using the desktop application and the mobile application.

### DESCRIPTION OF THE DRAWINGS

FIG. 1 illustrates a human resources (HR) management system, and environment thereof, according to at least one embodiment of the invention.

FIGS. 2-11 are screenshots of pages generated by the Desktop application according to the invention.

FIG. 2 shows the Login page for accessing the system.

FIG. 3 shows the Dashboard page displayed after a login to the system.

FIG. 4 shows the Messages page selected from the menu on the Dashboard page of FIG. 3.

FIG. 5 shows the Candidates page selected from the menu on the Dashboard page of FIG. 3.

FIG. 6 shows the Clients page selected from the menu on the Dashboard page of FIG. 3.

FIG. 7 shows the Projects page selected from the menu on the Dashboard page of FIG. 3.

FIG. 8 shows the Jobs page selected from the menu on the Dashboard page of FIG. 3.

FIG. 9 shows the Placements page selected from the menu on the Dashboard page of FIG. 3.

FIG. 10 shows the Favorite List page selected from the menu on the Dashboard page FIG. 3.

FIG. 11 shows the Email page that is displayed when one of the contacts listed on the Messages page of FIG. 4 is selected.

FIGS. 12-20 are screenshots of pages generated by the Mobile application according to the invention.

FIG. 12 shows the Home page generated when the Mobile application is opened.

FIG. 13 shows the Jobs page selected from the menu at the bottom of the Home page of FIG. 12.

FIG. 14 shows details of a job selected from the jobs listed on the Jobs page of FIG. 13.

FIG. 15 shows the Right to Represent Form page accessed from the Jobs page of FIG. 14.

FIG. 16 shows the Messages page selected from the menu at the bottom of the Home page of FIG. 12.

FIG. 17 shows the My Jobs page selected from the menu at the bottom of the Home page of FIG. 12.

FIG. 18 shows the Profile page accessed from the My Jobs page of FIG. 17.

FIG. 19 shows the Skill Sets page accessed from the Profile page of FIG. 18.

FIG. 20 shows the Select Availability Date page accessed from the Skill Sets page of FIG. 19.

### DETAILED DESCRIPTION OF THE INVENTION

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

Embodiments of the present invention described herein, with reference to flowchart illustrations and/or block diagrams of methods or apparatuses (the term “apparatus” includes systems and computer program products), will be understood such that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein.

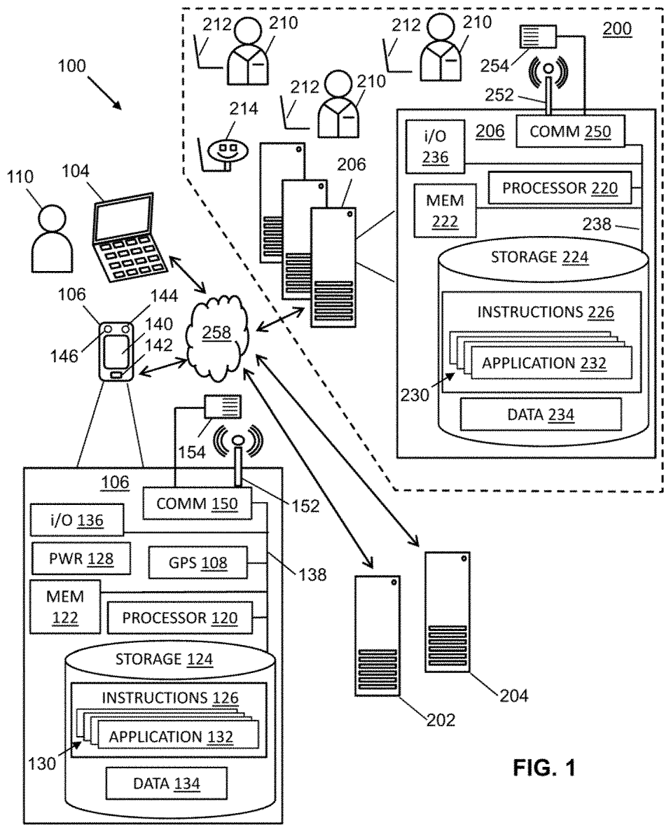

FIG. 1 illustrates a system 100 and environment thereof, according to at least one embodiment, for managing human resources by which a user 110 benefits through the use of services provided by a human resources (HR) management system 200 operating according to the invention. The user 110 accesses services by use of one or more user devices, illustrated in separate examples as a computing device 104 and a mobile device 106, which may be, as non-limiting examples, a smart phone, a portable digital assistant (PDA), a laptop computer, or any combination of the aforementioned, or other portable device with processing and communication capabilities. In the illustrated example, the mobile device 106 is illustrated in FIG. 1 as having exemplary elements, the below descriptions of which apply as well to the computing device 104, which can be, as non-limiting examples, a desktop computer, a laptop computer, or other user-accessible computing device.

Furthermore, the user device, referring to either or both of the computing device 104 and the mobile device 106, may be or include a workstation, a server, or any other suitable device, including a set of servers, a cloud-based application or system, or any other suitable system, adapted to execute, for example any suitable operating system, including Linux, UNIX, Windows, macOS, iOS, Android and any other known operating system used on personal computers, central computing systems, phones, and other devices.

The user 110 can be an individual, a group, or any entity in possession of or having access to the user device, referring to either or both of the mobile device 104 and computing device 106, which may be personal or public items. Although the user 110 may be singly represented in some drawings, at least in some embodiments according to these descriptions the user 110 is one of many such that a community of users, consumers, customers, business entities, government entities, and groups of any size are all within the scope of these descriptions.

The user device, as illustrated with reference to the mobile device 106, includes components such as, at least one of each of a processing device 120, and a memory device 122 for processing use, such as random access memory (RAM), and read-only memory (ROM). The illustrated mobile device 106 further includes a storage device 124 including at least one of a non-transitory storage medium, such as a microdrive, for long-term, intermediate-term, and short-term storage of computer-readable instructions 126 for execution by the processing device 120. For example, the instructions 126 can include instructions for an operating system and various applications or programs 130, of which the application (HR Mobile App) 132 is represented as a particular example. The HR Mobile App 132 provides the user 110 with access to the HR management system 200 as described below. The storage device 124 can store various other data items 134, which can include, as non-limiting examples, cached data, user files such as those for pictures, audio and/or video recordings, files downloaded or received from other devices, and other data items preferred by the user or required or related to any or all of the applications or programs 130.

The memory device 122 is operatively coupled to the processing device 120. As used herein, memory includes any computer readable medium to store data, code, or other information. The memory device 122 may include volatile memory, such as volatile Random Access Memory (RAM) including a cache area for the temporary storage of data. The memory device 122 may also include non-volatile memory, which can be embedded and/or may be removable. The non-volatile memory can additionally or alternatively include an electrically erasable programmable read-only memory (EEPROM), flash memory or the like.

The memory device 122 and storage device 124 can store any of a number of applications which comprise computer-executable instructions and code executed by the processing device 120 to implement the functions of the mobile device 106 described herein. For example, the memory device 122 may include such applications as a conventional web browser application and/or a mobile P2P payment system client application. These applications also typically provide a graphical user interface (GUI) on the display 140 that allows the user 110 to communicate with the mobile device 106, and, for example a mobile banking system, and/or other devices or systems.

The processing device 120, and other processors described herein, generally include circuitry for implementing communication and/or logic functions of the mobile device 106. For example, the processing device 120 may include a digital signal processor, a microprocessor, and various analog to digital converters, digital to analog converters, and/or other support circuits. Control and signal processing functions of the mobile device 106 are allocated between these devices according to their respective capabilities. The processing device 120 thus may also include the functionality to encode and interleave messages and data prior to modulation and transmission. The processing device 120 can additionally include an internal data modem. Further, the processing device 120 may include functionality to operate one or more software programs, which may be stored in the memory device 122, or in the storage device 124. For example, the processing device 120 may be capable of operating a connectivity program, such as a web browser application. The web browser application may then allow the mobile device 106 to transmit and receive web content, such as, for example, location-based content and/or other web page content, according to a Wireless Application Protocol (WAP), Hypertext Transfer Protocol (HTTP), and/or the like.

The memory device 122 and storage device 124 can each also store any of a number of pieces of information, and data, used by the user device and the applications and devices that facilitate functions of the user device, or are in communication with the user device, to implement the functions described herein and others not expressly described. For example, the storage device may include such data as user authentication information, etc.

The processing device 120, in various examples, can operatively perform calculations, can process instructions for execution, and can manipulate information. The processing device 120 can execute machine-executable instructions stored in the storage device 124 and/or memory device 122 to thereby perform methods and functions as described or implied herein, for example by one or more corresponding flow charts expressly provided or implied as would be understood by one of ordinary skill in the art to which the subject matters of these descriptions pertain. The processing device 120 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof. In some embodiments, particular portions or steps of methods and functions described herein are performed in whole or in part by way of the processing device 120, while in other embodiments methods and functions described herein include cloud-based computing in whole or in part such that the processing device 120 facilitates local operations including, as non-limiting examples, communication, data transfer, and user inputs and outputs such as receiving commands from and providing displays to the user.

The mobile device 106, as illustrated, includes an input and output system 136, referring to, including, or operatively coupled with, user input devices and user output devices, which are operatively coupled to the processing device 120. The user output devices include a display 140 (e.g., a liquid crystal display or the like), which can be, as a non-limiting example, a touch screen of the mobile device 106, which serves both as an output device, by providing graphical and text indicia and presentations for viewing by one or more user 110, and as an input device, by providing virtual buttons, selectable options, a virtual keyboard, and other indicia that, when touched, control the mobile device 106 by user action. The user output devices include a speaker 144 or other audio device. The user input devices, which allow the mobile device 106 to receive data and actions such as button manipulations and touches from a user such as the user 110, may include any of a number of devices allowing the mobile device 106 to receive data from a user, such as a keypad, keyboard, touch-screen, touchpad, microphone 142, mouse, joystick, other pointer device, button, soft key, and/or other input device(s). The user interface may also include a camera 146, such as a digital camera.

Further non-limiting examples include, one or more of each, any, and all of a wireless or wired keyboard, a mouse, a touchpad, a button, a switch, a light, an LED, a buzzer, a bell, a printer and/or other user input devices and output devices for use by or communication with the user 110 in accessing, using, and controlling, in whole or in part, the user device, referring to either or both of the computing device 104 and a mobile device 106. Inputs by one or more user 110 can thus be made via voice, text or graphical indicia selections. For example, such inputs in some examples correspond to user-side actions and communications seeking services of the HR management system 200, and at least some outputs in such examples correspond to data representing management system-side actions and communications in two-way communications between a user 110 and the HR management system 200.

The mobile device 106 may also include a positioning device 108, which can be for example a global positioning system device (GPS) configured to be used by a positioning system to determine a location of the mobile device 106. For example, the positioning system device 108 may include a GPS transceiver. In some embodiments, the positioning system device 108 includes an antenna, transmitter, and receiver. For example, in one embodiment, triangulation of cellular signals may be used to identify the approximate location of the mobile device 106. In other embodiments, the positioning device 108 includes a proximity sensor or transmitter, such as an RFID tag, that can sense or be sensed by devices known to be located proximate a location to determine that the mobile device 106 is located proximate these known devices.

In the illustrated example, a system intraconnect 138, connects, for example electrically, the various described, illustrated, and implied components of the mobile device 106. The intraconnect 138, in various non-limiting examples, can include or represent, a system bus, a high-speed interface connecting the processing device 120 to the memory device 122, individual electrical connections among the components, and electrical conductive traces on a motherboard common to some or all of the above-described components of the user device. As discussed herein, the system intraconnect 138 may operatively couple various components with one another, or in other words, electrically connects those components, either directly or indirectly—by way of intermediate component(s)—with one another.

The user device, referring to either or both of the computing device 104 and the mobile device 106, with particular reference to the mobile device 106 for illustration purposes, includes a communication interface 150, by which the mobile device 106 communicates and conducts transactions with other devices and systems. The communication interface 150 may include digital signal processing circuitry and may provide two-way communications and data exchanges, for example wirelessly via wireless communication device 152, and for an additional or alternative example, via wired or docked communication by mechanical electrically conductive connector 154. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless communication device 152, which can be or include a radio-frequency transceiver, a Bluetooth device, Wi-Fi device, a Near-field communication device, and other transceivers. In addition, GPS (Global Positioning System) may be included for navigation and location-related data exchanges, ingoing and/or outgoing. Communications may also or alternatively be conducted via the connector 154 for wired connections such by USB, Ethernet, and other physically connected modes of data transfer.

The processing device 120 is configured to use the communication interface 150 as, for example, a network interface to communicate with one or more other devices on a network. In this regard, the communication interface 150 utilizes the wireless communication device 152 as an antenna operatively coupled to a transmitter and a receiver (together a “transceiver”) included with the communication interface 150. The processing device 120 is configured to provide signals to and receive signals from the transmitter and receiver, respectively. The signals may include signaling information in accordance with the air interface standard of the applicable cellular system of a wireless telephone network. In this regard, the mobile device 106 may be configured to operate with one or more air interface standards, communication protocols, modulation types, and access types. By way of illustration, the mobile device 106 may be configured to operate in accordance with any of a number of first, second, third, fourth, fifth-generation communication protocols and/or the like. For example, the mobile device 106 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The mobile device 106 may also be configured to operate in accordance with non-cellular communication mechanisms, such as via a wireless local area network (WLAN) or other communication/data networks.

The mobile device 106 further includes a power source 128, such as a battery, for powering various circuits and other devices that are used to operate the mobile device 106. Embodiments of the mobile device 106 may also include a clock or other timer configured to determine and, in some cases, communicate actual or relative time to the processing device 120 or one or more other devices. For further example, the clock may facilitate timestamping transmissions, receptions, and other data for security, authentication, logging, polling, data expiry, and forensic purposes.

System 100 as illustrated diagrammatically represents at least one example of a possible implementation, where alternatives, additions, and modifications are possible for performing some or all of the described methods, operations and functions. Although shown separately, in some embodiments, two or more systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The human resources (HR) management system 200 can offer any number or type of services to one or more users 110. To provide access to, or information regarding, some or all of the services of the HR management system 200, automated assistance may be provided by the HR management system 200. For example, automated access to user accounts and replies to inquiries may be provided by management system-side automated voice, text, and graphical display communications and interactions. In at least some examples, any number of human agents 210, can be employed, utilized, authorized or referred by the HR management system 200. Such human agents 210 can be, as non-limiting examples, online service assistants and field managers available to the users 110, advisors, managers, sales team members, and referral agents ready to route user requests and communications to preferred or particular other agents, human or virtual.

Human agents 210 may utilize agent devices 212 to serve users in their interactions to communicate and take action. The agent devices 212 can be, as non-limiting examples, computing devices, kiosks, terminals, smart devices such as phones, and devices and tools at service counters and desks. In at least one example, the diagrammatic representation of the components of the user device 106 in FIG. 1 applies as well to one or both of the computing device 104 and the agent devices 212.

Agent devices 212 individually or collectively include input devices and output devices, including, as non-limiting examples, a touch screen, which serves both as an output device by providing graphical and text indicia and presentations for viewing by one or more agent 210, and as an input device by providing virtual buttons, selectable options, a virtual keyboard, and other indicia that, when touched or activated, control or prompt the agent device 212 by action of the attendant agent 210. Further non-limiting examples include, one or more of each, any, and all of a keyboard, a mouse, a touchpad, a joystick, a button, a switch, a light, an LED, a microphone serving as input device for example for voice input by a human agent 210, a speaker serving as an output device, a camera serving as an input device, a buzzer, a bell, a printer and/or other user input devices and output devices for use by or communication with a human agent 210 in accessing, using, and controlling, in whole or in part, the agent device 212.

Inputs by one or more human agents 210 can thus be made via voice, text or graphical indicia selections. For example, some inputs received by an agent device 212 in some examples correspond to, control, or prompt management system-side actions and communications offering services and products of the HR management system 200, information thereof, or access thereto. At least some outputs by an agent device 212 in some examples correspond to, or are prompted by, user-side actions and communications in two-way communications between a user 110 and a management system-side human agent 210.

From a user perspective experience, an interaction in some examples within the scope of these descriptions begins with direct or first access to one or more human agents 210 in person, by phone, or online for example via a chat session or website function or feature. In other examples, a user is first assisted by a virtual agent 214 of the HR management system 200, which may satisfy user requests or prompts by voice, text, or online functions, and may refer users to one or more human agents 210 once preliminary determinations or conditions are made or met.

A computing system 206 of the HR management system 200 may include components such as, at least one of each of a processing device 220, and a memory device 222 for processing use, such as random access memory (RAM), and read-only memory (ROM). The illustrated computing system 206 further includes a storage device 224 including at least one non-transitory storage medium, such as a microdrive, for long-term, intermediate-term, and short-term storage of computer-readable instructions 226 for execution by the processing device 220. For example, the instructions 226 can include instructions for an operating system and various applications or programs 230, of which the application (HR Management App) 232 is represented as a particular example. The storage device 224 can store various other data 234, which can include, as non-limiting examples, cached data, and files such as those for user accounts, user profiles, and transaction histories, files downloaded or received from other devices, and other data items preferred by the user or required or related to any or all of the applications or programs 230. Any or all of the data 234 can be organized in one or more databases.

The computing system 206, in the illustrated example, includes an input/output system 236, referring to, including, or operatively coupled with input devices and output devices such as, in a non-limiting example, agent devices 212, which have both input and output capabilities.

In the illustrated example, a system intraconnect 238 electrically connects the various above-described components of the computing system 206. In some cases, the intraconnect 238 operatively couples components to one another, which indicates that the components may be directly or indirectly connected, such as by way of one or more intermediate components. The intraconnect 238, in various non-limiting examples, can include or represent, a system bus, a high-speed interface connecting the processing device 220 to the memory device 222, individual electrical connections among the components, and electrical conductive traces on a motherboard common to some or all of the above-described components of the user device.

The computing system 206, in the illustrated example, includes a communication interface 250, by which the computing system 206 communicates and conducts transactions with other devices and systems. The communication interface 250 may include digital signal processing circuitry and may provide two-way communications and data exchanges, for example wirelessly via wireless device 252, and for an additional or alternative example, via wired or docked communication by mechanical electrically conductive connector 254.

Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless device 252, which can be or include a radio-frequency transceiver, a Bluetooth device, Wi-Fi device, Near-field communication device, and other transceivers. In addition, GPS (Global Positioning System) may be included for navigation and location-related data exchanges, ingoing and/or outgoing. Communications may also or alternatively be conducted via the connector 254 for wired connections such as by USB, Ethernet, and other physically connected modes of data transfer.

The processing device 220, in various examples, can operatively perform calculations, can process instructions for execution, and can manipulate information. The processing device 220 can execute machine-executable instructions stored in the storage device 224 and/or memory device 222 to thereby perform methods and functions as described or implied herein, for example by one or more corresponding flow charts expressly provided or implied as would be understood by one of ordinary skill in the art to which the subjects matters of these descriptions pertain. The processing device 220 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof.

Furthermore, the computing device 206, may be or include a workstation, a server, or any other suitable device, including a set of servers, a cloud-based application or system, or any other suitable system, adapted to execute, for example any suitable operating system, including Linux, UNIX, Windows, macOS, iOS, Android, and any known other operating system used on personal computer, central computing systems, phones, and other devices.

The user devices, referring to either or both of the mobile device 104 and computing device 106, the agent devices 212, and the HR management computing system 206, which may be one or any number centrally located or distributed, are in communication through one or more networks, referenced as network 258 in FIG. 1.

Network 258 provides wireless or wired communications among the components of the system 100 and the environment thereof, including other devices local or remote to those illustrated, such as additional mobile devices, servers, and other devices communicatively coupled to network 258, including those not illustrated in FIG. 1. The network 258 is singly depicted for illustrative convenience, but may include more than one network without departing from the scope of these descriptions. In some embodiments, the network 258 may be or provide one or more cloud-based services or operations. The network 258 may be or include a system or secured network, or may be implemented, at least in part, through one or more connections to the Internet. A portion of the network 258 may be a virtual private network (VPN) or an Intranet. The network 258 can include wired and wireless links, including, as non-limiting examples, 802.11a/b/g/n/ac, 802.20, WiMax, LTE, and/or any other wireless link. The network 258 may include any internal or external network, networks, sub-network, and combinations of such operable to implement communications between various computing components within and beyond the illustrated environment 100. The network 258 may communicate, for example, Internet Protocol (IP) packets, Frame Relay frames, Asynchronous Transfer Mode (ATM) cells, voice, video, data, and other suitable information between network addresses. The network 258 may also include one or more local area networks (LANs), radio access networks (RANs), metropolitan area networks (MANs), wide area networks (WANs), all or a portion of the internet and/or any other communication system or systems at one or more locations.

Two external systems 202 and 204 are expressly illustrated in FIG. 1, representing any number and variety of data sources, users, customers, business entities, government entities, and groups of any size are all within the scope of the descriptions.

In certain embodiments, one or more of the systems such as the user device 106, the HR management system 200, and/or the external systems 202 and 204 are, include, or utilize virtual resources. In some cases, such virtual resources are considered cloud resources or virtual machines. Such virtual resources may be available for shared use among multiple distinct resource consumers and in certain implementations, virtual resources do not necessarily correspond to one or more specific pieces of hardware, but rather to a collection of pieces of hardware operatively coupled within a cloud computing configuration so that the resources may be shared as needed.

The HR management system 200 is used to manage a pool of job candidates and employees, who are represented by the user 110, in coordination with a plurality of jobs associated with projects of clients. These job candidate and employee users 110 communicate with the HR management system using the HR Mobile App 132 running on their computing device 104 and/or mobile device 106.

The human agents 210 include field managers who communicate with the HR management system 200 using of both the HR Mobile App 132 and the HR Desktop App 232. The human agents 210 also include the clients who communicate with the HR management system 200 using HR Desktop App 232.

The HR Mobile App 132 enables the job candidates and employees to perform the following tasks: profile creation/updating; resume/certification/training uploading; update availability for jobs; send notification to field manager about placement details—extensions, etc.; submit interest in jobs posted on the job page; respond to, accept or decline, notifications of potential jobs from field managers; and utilize a timesheet module to complete timesheets as placements on projects.

A client is be an individual or a group of individuals associated with a company. The HR Desktop App 232 enables the client to perform the following tasks: update profile information; assign an administrator to post/edit jobs on behalf of the company; search a blinded resume database and select resumes that fit criteria and submit interest; and approve or reject timesheets.

The HR Mobile App 132 and the HR Desktop App 232 enable the field managers to perform the following tasks: search a candidate database and send out notifications while on the go; interact with clients via notifications.

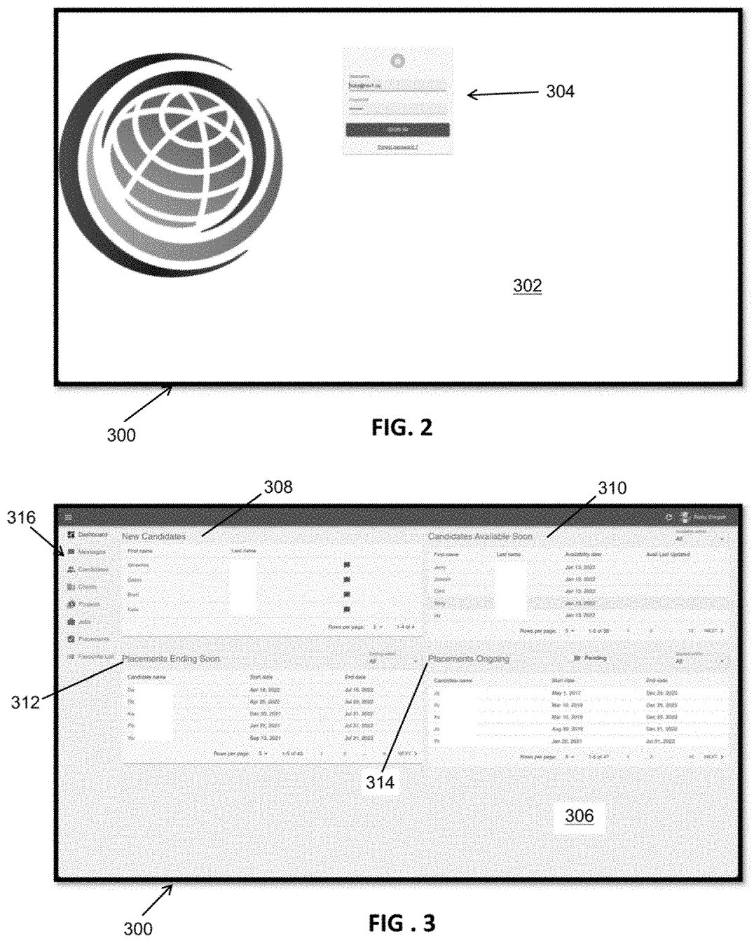

FIGS. 2-11 are screenshots of pages generated by the HR Desktop App 232 according to the invention. FIG. 2 shows a display 300 on which the HR Desktop App 232 generates a Login page 302 for accessing the system 200. The page 302 includes a data entry box 304 for the user to enter a Username and a Password. In response to confirmation of the data entered in the box 304, the App 232 generates a Dashboard page 306 on the display 300 as shown in FIG. 3. The Dashboard page 306 includes a New Candidates list 308, a Candidates Available Soon list 310, a Placements Ending Soon list 312 and a Placements Ongoing list 314. The New Candidates list 308 includes the names of new candidates that can be clicked on to access an associated resume. The Candidates Available Soon list 310 includes the names of candidates who will become available for placement and an associated availability date. The Placements Ending Soon list 312 includes the names of candidates with the start and end dates of the associated placement that will end soon. The Placements Ongoing list 314 includes the names of candidates with the start and end dates of the associated placement that will not end soon. At the upper left of the Dashboard page 306 is a menu 316 for selecting the following pages to be displayed: a Messages page; a Candidates page; a Clients page; a Projects page; a Jobs page; a Placements page; and a Favorite List page.

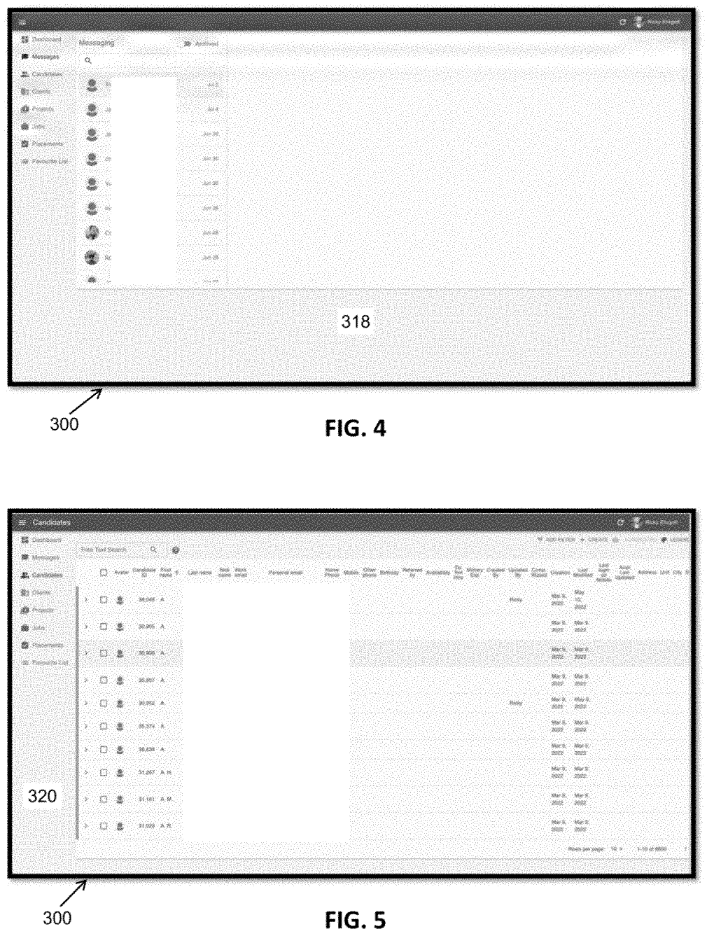

FIG. 4 shows the Messages page 318 selected from the menu 316 on the Dashboard page 306 of FIG. 3. The page 318 includes a list of contact names each of which can be selected for sending a message. FIG. 5 shows the Candidates page 320 selected from the menu 316 on the Dashboard page 306 of FIG. 3. The page 320 includes a list of candidates maintained in the storage device 224. Each candidate name is displayed with associated contact and profile information such as email addresses, telephone numbers and availability for jobs.

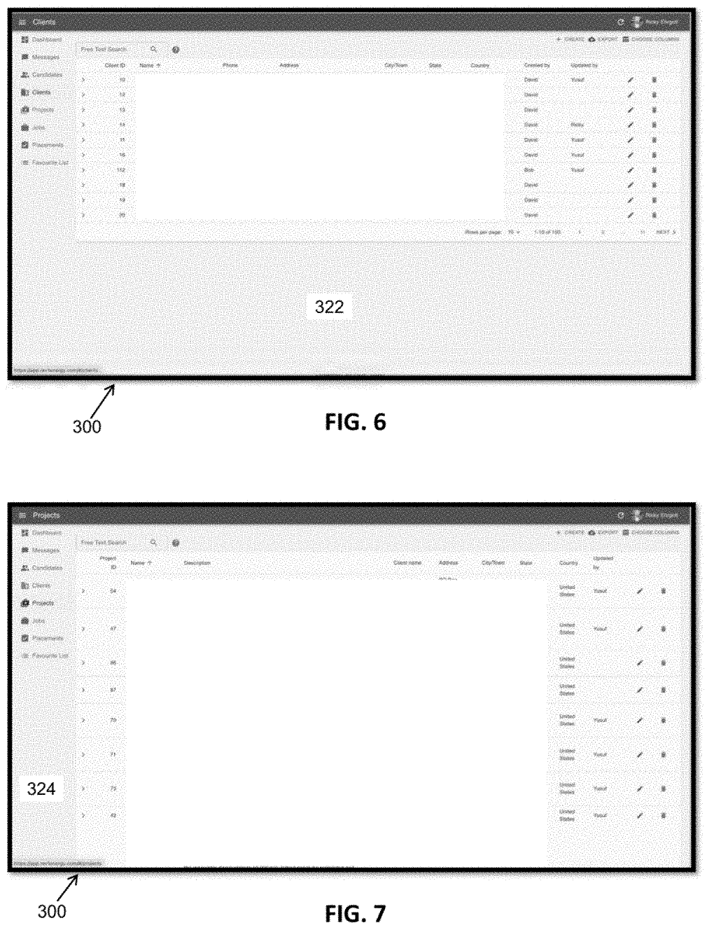

FIG. 6 shows the Clients page 322 selected from the menu 316 on the Dashboard page 306 of FIG. 3. The page 322 includes a list of clients displayed with associated contact information. The clients are companies that had, currently have or may have in the future have projects with jobs that require staffing by candidates. FIG. 7 shows the Projects page 324 selected from the menu 316 on the Dashboard page 306 of FIG. 3. The page 324 lists the projects with associated project ID, project name, project description, client name and client address.

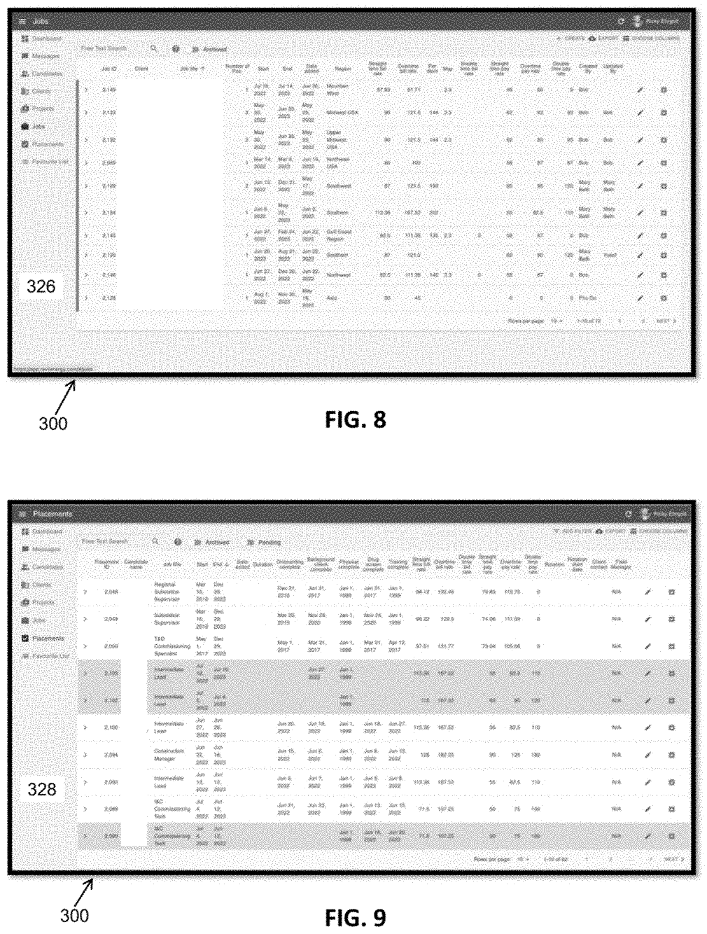

FIG. 8 shows the Jobs page 326 selected from the menu 316 on the Dashboard page 306 of FIG. 3. The page 326 lists the jobs associated with the projects (see page 324) with associated job ID, client name, job start and end dates, billing rates and pay rates. FIG. 9 shows the Placements page 328 selected from the menu 316 on the Dashboard page 306 of FIG. 3. The page 328 lists the placed candidates names with associated placement ID, job title, job start and end dates, dates on which various requirements were completed, billing rates and pay rates. A candidate placed in a job is designed as an employee. The end date for an employee in a job and the available date for the next job are different fields because the employee may not be immediately available as of the end date. One month prior to end date, system 200 sends a notification to the associated field manager notifying to confirm the end date with employee. If the end date is confirmed, then the system 200 will auto close out the placement and return the employee to candidate status based on the availability date. The system 200 has the capability to submit candidates who are placements on current jobs for new jobs thereby allowing an employee to roll from one job to the next.

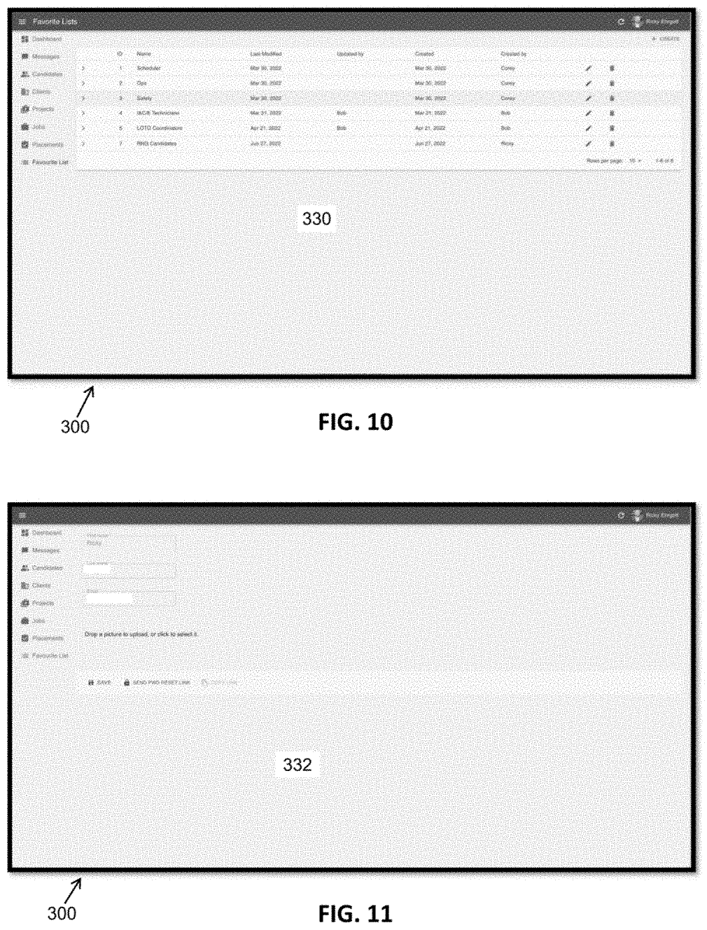

FIG. 10 shows the Favorite List page 330 selected from the menu 316 on the Dashboard page 306 FIG. 3. The page 330 shows the names of frequently used links selected by the user. FIG. 11 shows the Email page 332 that is displayed when one of the contacts listed on the Messages page 318 of FIG. 4 is selected. The page 332 enables the user to send email messages with picture attachments.

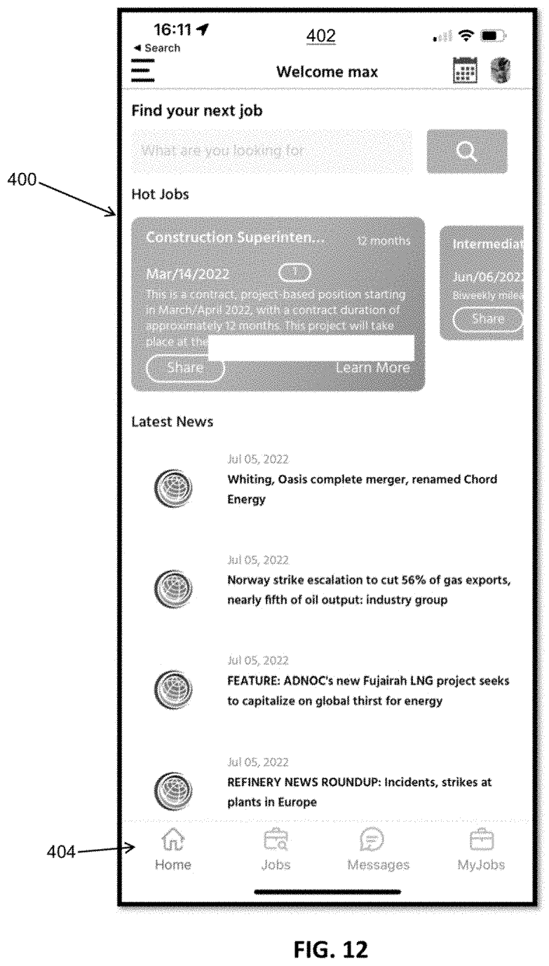

FIGS. 12-20 are screenshots of pages generated by the HR Mobile App 132 according to the invention. FIG. 12 shows a display 400 on which the HR Mobile App 132 generates a Home page 402 when the Mobile application is opened. The display 400 can be a display of the computing device 104 or the display 140 of the mobile device 106 shown in FIG. 1. The page 402 includes a “Find your next job” search feature and a “Latest News” list of stories related to industries of interest. A menu 404 across the bottom of page 402 enables the user to switch among the Home page 402, a Jobs page, a Messages page and a MyJobs page.

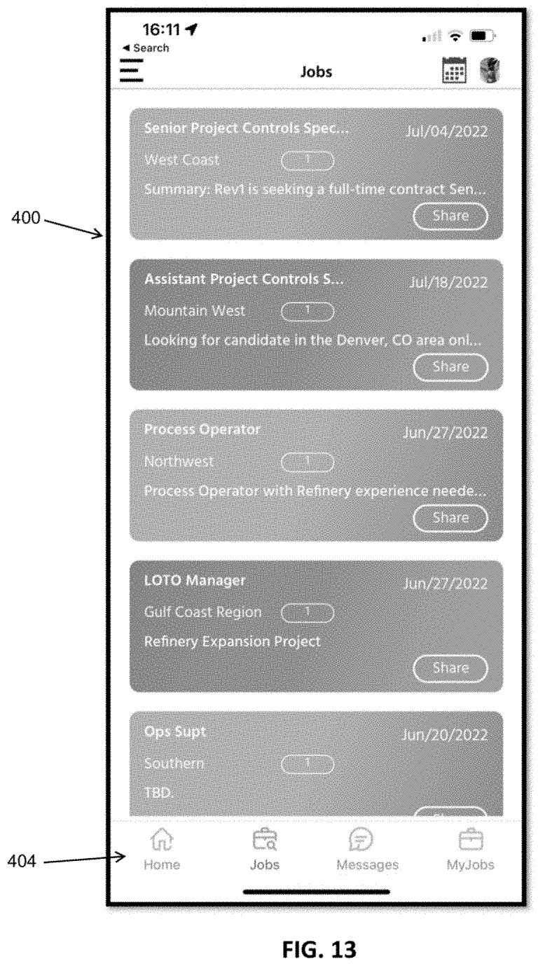

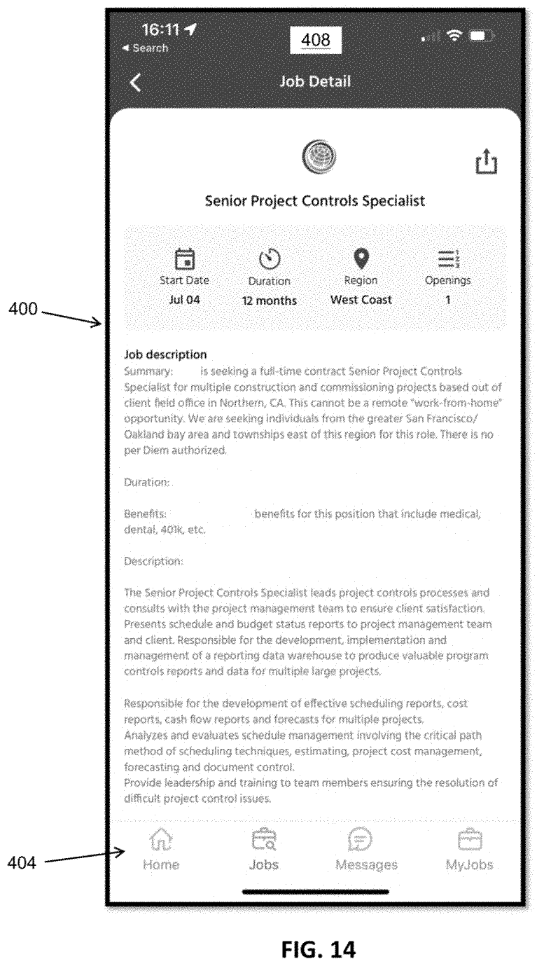

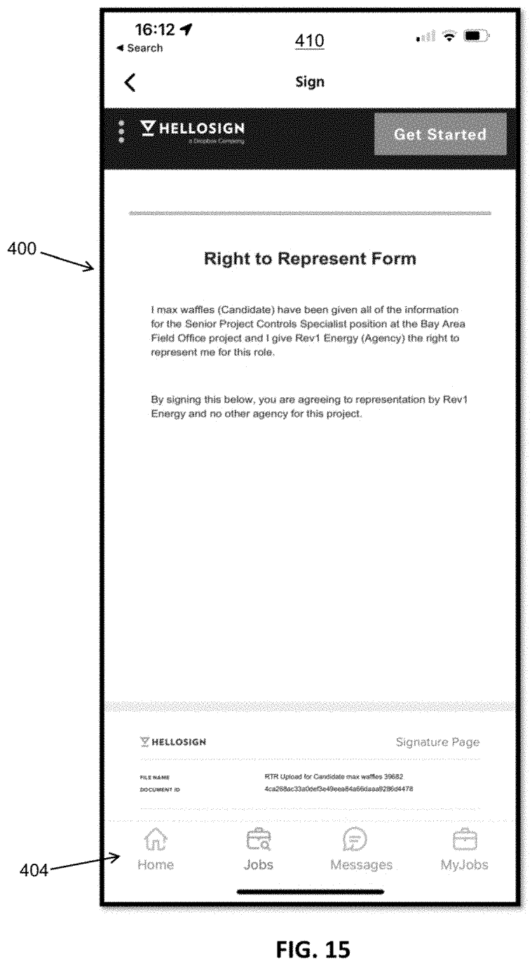

FIG. 13 shows the Jobs page 406 selected from the menu 404. The page 406 lists available jobs and the associated start dates. FIG. 14 shows a Job Detail page 408 generated by the HR Mobile App 132 when one the jobs listed on the Jobs page 406 of FIG. 13 is selected. The page 408 shows the job title, a job description, a duration of the job and any benefits provided. FIG. 15 shows a Right to Represent Form page 410 accessed from the Job Detail page 408 of FIG. 14. The page 410 enables the user to agree to representation by the operator of the HR management system 200 as a requirement to be considered for a listed job.

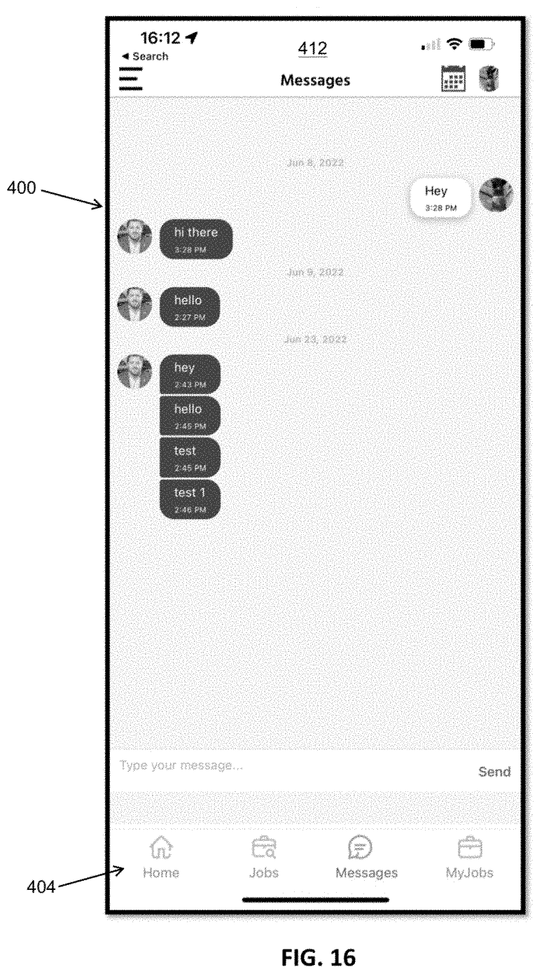

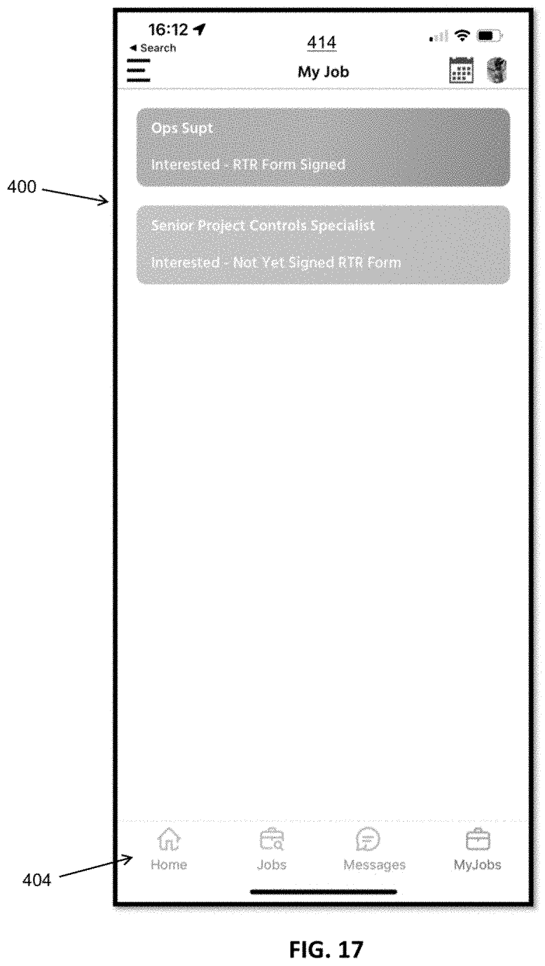

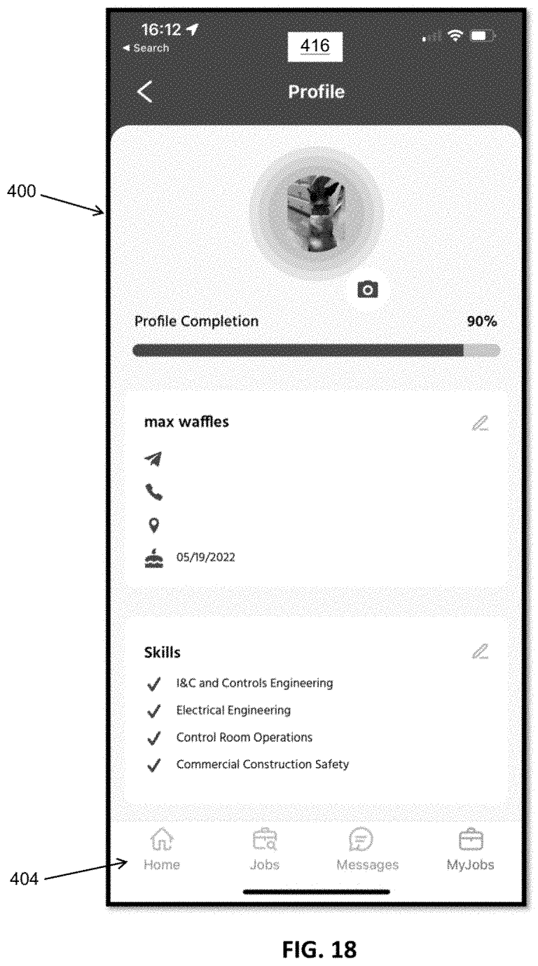

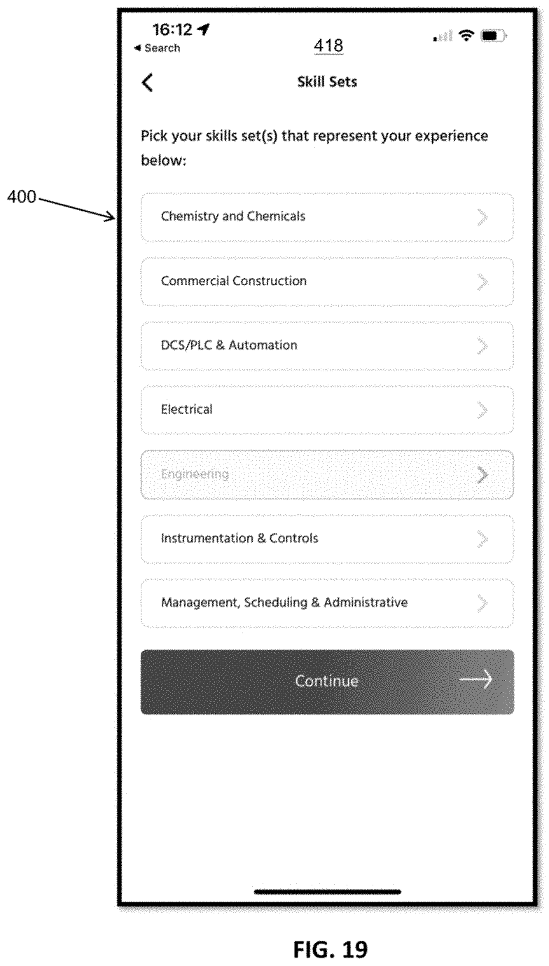

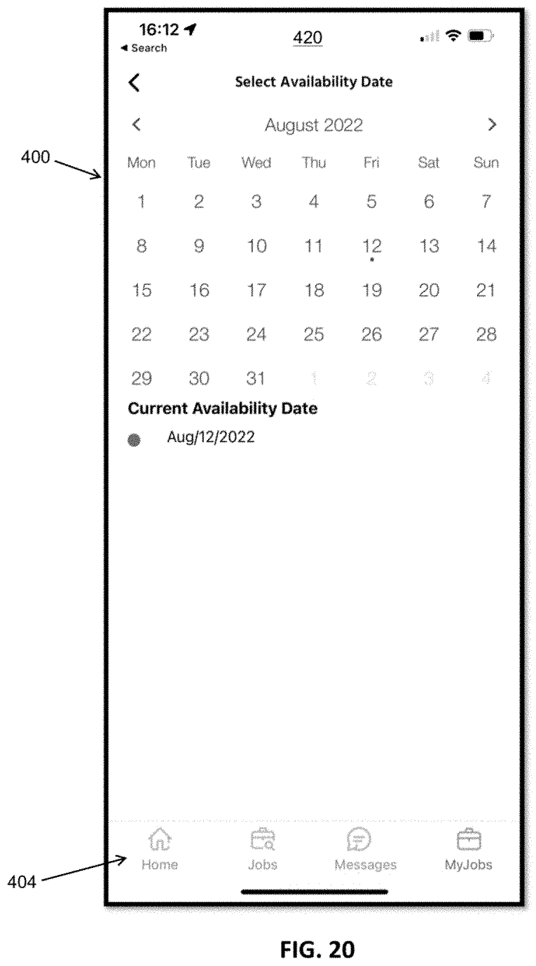

FIG. 16 shows the Messages page 412 selected from the menu 404. The page 412 lists the messages sent and received by the user and enables the user to send new messages. FIG. 17 shows the MyJobs page 414 selected from the menu 404. The page 414 shows the jobs of interest selected by the user and whether the Right to Represent form (FIG. 15) has been signed by the user. FIG. 18 shows a Profile page 416 accessed from the MyJobs page 414 of FIG. 17. The page 416 enables the user to provide personal information such as contact information and work skills. FIG. 19 shows the Skill Sets page 418 accessed from the Profile page 416 of FIG. 18. The page 418 lists skill sets that can be selected by the user to include in the profile shown on the page 416. FIG. 20 shows a Select Availability Date page 420 accessed from the Skill Sets page 418 of FIG. 19. The page 420 enables the user to enter an availability date for placement in a job.

A job prospect enters a placement pending stage managed by an HR supervisor of the entity operating the HR management system 200. The HR supervisor updates the prospect's data in the system as the data is received. A push notification or an alert can be sent to the field managers when any of the prospect information is updated. When the prospect has met all of the requirements, the HR manager will then confirm via a “Clear to Placement” input and the placement pending status will then become an official placement status changing the prospect to a candidate. After the placement pending stage is complete and the candidate is “cleared to placement”, the candidate becomes an employee of the system operator.

After a field manager has submitted candidates to a client, the client selects one or more of the candidates and communicates to the field manager to begin the onboarding process. A drug screening and background check is then initialized and managed by the HR supervisor along with several other steps of a Background Screen, a Drug Screen, a Physical and Training Completion as listed in page 328 shown in FIG. 9. Field managers can notify candidates of jobs they may be interested in. Candidates can register interest in jobs via notification or by searching the listed jobs.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A system for managing human resources to provide employees to clients having job openings associated with projects, the system comprising:
a computing system operatively wirelessly operatively coupled over a wireless communication network with a plurality of user portable devices and a plurality of client devices;
the computing system including a processing device connected to a data storage device and communication interface, the communication interface communicatively coupled to the communication network;
a memory device storing executable code that, when executed, causes the processing device to run a desktop application that stores information for a plurality of clients, a plurality of projects associated with the clients, a plurality of job openings associated with the projects and a plurality of profiles of employees in the data storage device, the employees being represented by an operator of the system;
the client devices communicating with the computing system across the wireless communication network to provide the information related to the projects and the job openings to be stored in the data storage device; and
the user portable devices each including a user processing device connected to a user memory device storing executable code that, when executed, causes the user processing device to run a mobile application that connects the user portable device to the wireless communication network to provide information related to the profiles and to search the job openings.

2. The system according to claim 1 wherein the running desktop application generates a Dashboard page on a display, the Dashboard page including a New Candidates list, a Candidates Available Soon list, a Placements Ending Soon list and a Placements Ongoing list, wherein the New Candidates list includes names of new candidates that can be clicked on to access an associated one of the employee profiles.

3. The system according to claim 1 wherein the running desktop application generates a Messages page on a display, wherein the Messages page includes a list of contact names each of which can be selected for sending a message.

4. The system according to claim 1 wherein the running desktop application generates a Candidates page on a display, wherein the Candidates page includes a list of candidate names associated with the employee profiles maintained in the data storage device, each of candidate names being displayed with associated contact and profile information such as email addresses, telephone numbers and availability for jobs.

5. The system according to claim 1 wherein the running desktop application generates a Clients page on a display, the Clients page including a list of the clients maintained in the data storage device, each of the client names being displayed with associated contact information.

6. The system according to claim 1 wherein the running desktop application generates a Projects page on a display, the Projects page including a list the projects maintained in the data storage device, each of the projects being displayed with associated project ID, project name, project description, client name and client address.

7. The system according to claim 1 wherein the running desktop application generates a Jobs page on a display, the Jobs page including a list the jobs associated with the projects maintained in the data storage device, each of the jobs being displayed with associated job ID, client name, job start and end dates, billing rates and pay rates.

8. The system according to claim 1 wherein the running desktop application generates a Placements page on a display, the Placements page including a list of placed candidate names maintained in the data storage device, each of the candidate names being displayed with associated placement ID, job title, job start and end dates, dates on which various requirements were completed, billing rates and pay rates.

9. The system according to claim 1 wherein the running desktop application generates a Favorite List page on a display, the Favorite List page including names of frequently used links selected by a user of the computing system.

10. The system according to claim 1 wherein the running desktop application generates an Email page on a display in response to a selection of a contact stored in the data storage device, the Messages page enabling a user of the computing system to send email messages with picture attachments.

11. The system according to claim 1 wherein the running mobile application generates a Home page on a portable device display of one of the user portable devices, the Home page including a “Find your next job” search feature and a “Latest News” list of stories related to industries of interest.

12. The system according to claim 1 wherein the running mobile application generates a Jobs page on a portable display of one of the user portable devices, the Jobs page including a list available jobs and associated start dates stored in the data storage device.

13. The system according to claim 12 wherein the running mobile application generates a Job Detail page when one the available jobs listed on the Jobs page is selected, the Job Detail page showing a job title, a job description, a duration of the job and any benefits provided.

14. The system according to claim 13 wherein the running mobile application generates a Right to Represent Form page accessed from the Job Detail page, the page Right to Represent Form page enabling a user of the one user portable device to agree to representation by the operator of the system as a requirement to be considered for one of the listed jobs.

15. The system according to claim 1 wherein the running mobile application generates a Messages page on a portable device display of one of the user portable devices, the Messages page listing messages sent and received by the user of the one user portable device and enables the user to send new messages.

16. The system according to claim 1 wherein the running mobile application generates a MyJobs page on a portable device display of one of the user portable devices, the MyJobs page jobs of interest selected by the user of the one user portable device and whether a Right to Represent form has been signed by the user.

17. The system according to claim 16 wherein the running mobile application generates a Profile page accessed from the MyJobs page, the Profile page enabling the user to provide personal information including contact information and work skills.

18. The system according to claim 17 wherein the running mobile application generates a Skill Sets page accessed from the Profile page, the Skill Sets page listing skill sets that can be selected by the user to include in the profile of the user.

19. A method for managing human resources to provide employees to clients having job openings associated with projects, the method comprising the following steps:
proving the system according to claim 1;
enabling a plurality of clients to communicate with the system over the wireless communication network using the desktop application; and
enabling a plurality of users to communicate with the system over the wireless communication network using the mobile application.

20. The method according to claim 19 including enabling a plurality of field managers to communicate with the system over the wireless communication network using the desktop application and the mobile application.
